(19) United States
(12) Patent Application Publication
(10) Pub. No.: US 2013/0086359 A1
(43) Pub. Date: Apr. 4, 2013

(54) Processor Hardware Pipeline Configured for Single-Instruction Address Extraction and Memory Access Operation

(71) Applicants: Subrato K. De, San Diego, CA (US); Michael W. Morrow, Wilkes Barre, PA (US); Moinul H. Khan, San Diego, CA (US); Mark Bapst, San Diego, CA (US)

(72) Inventors: Subrato K. De, San Diego, CA (US); Michael W. Morrow, Wilkes Barre, PA (US); Moinul H. Khan, San Diego, CA (US); Mark Bapst, San Diego, CA (US)

(73) Assignee: QUALCOMM INCORPORATED, San Diego, CA (US)

(21) Appl. No.: 13/248,329

(22) Filed: Sep. 29, 2011

(51) Int. Cl. G06F 12/00; G06F 9/30

(52) U.S. Cl. 712/205; 711/154; 711/E12.001; 712/E09.016

(57) ABSTRACT

Memory access instructions, such as load and store instructions, are processed in a processor-based system. Processor hardware pipeline configurations enable efficient performance of memory access instructions, such as a pipeline configuration that enables, for a memory access operation request by a register-operand based virtual machine, computation of the memory location corresponding to a virtual-machine register by extracting a bit-field from the virtual-machine instruction and accessing (load or store) the computed memory location that represents a virtual register of the virtual-machine, in a single pass through the pipeline. Thus this processor hardware pipeline configuration enables a virtual machine register read/write operation to be performed by a single hardware processor instruction through a single pass in the processor hardware pipeline, for a register-operand based virtual machine.

### TECHNICAL FIELD

The present disclosure generally relates to systems and methods for processing of memory access instructions, such as load and store instructions, in a processor-based system. More specifically, the present disclosure relates to processor hardware pipeline configurations for enabling a memory access operation request by a register-operand based virtual machine to extract a memory location to be accessed and to perform the requested memory access operation (e.g., load or store) on the extracted memory location in a single pass through the pipeline.

### BACKGROUND

A virtual machine (VM), sometimes referred to as a process VM or application

VM, runs as an application inside an operating system (OS) and supports a process. Its purpose is to provide a platform-independent programming environment that abstracts away details of the underlying hardware or OS, and allows a program to execute in the same way on any platform. Thus, a VM generally provides a high-level abstraction—that of a high-level programming language. Such VMs may be implemented using an interpreter; and performance comparable to compiled programming languages may be achieved in some instances by the use of just-in-time (JIT) compilation, for example.

VMs may be implemented using a stack-based model (such as the Java Virtual Machine (JVM)) or a register-based model. In a stack-based model, most instructions implicitly operate on values at the top of the stack and replace those values with the result. Such stack-based VMs may also have a “load” and a “store” instruction that reads and writes to arbitrary memory locations. Like all other instructions, the “load” and “store” instructions in stack-based VMs need no operands because they take the memory address from the top of the stack. Register-based models, on the other hand, generally employ a register-based addressing scheme in which a VM Instruction (VmI) of a program executing on the VM includes virtual register operands. The VmI in turn is loaded into the target processor hardware register “Rm” for further processing leading to the execution of VmI using a sequence of target processor instructions (TpI).

Dalvik, as one example, is a register-based virtual machine that runs a Java-like platform on Android mobile devices. Dalvik runs applications that have been converted into a compact Dalvik Executable (.dex) format suitable for systems constrained in terms of memory and processor speed. A tool called dx is used to convert Java .class files into the .dex format. Multiple classes may be included in a single .dex file. Duplicate strings and other constants in multiple class files are included only once in the .dex output to conserve space. Java bytecode is also converted into an alternate instruction set used by the Dalvik VM. An uncompressed .dex file can be a few percent smaller in size than a compressed .jar (Java Archive) derived from the same .class files.

FIG. 1 shows an exemplary block diagram of a system 100 in which a register-based VM is implemented. The system 100 includes processor hardware 101 and memory 102. As shown, the processor's memory 102 includes a VM 103 (implemented in software) that is executing. A program 104 is also included, which is executing on the VM 103. The program 104 includes a sequence of instructions that are coded for execution on the VM 103. Because the VM 103 is register-based, the program 104 uses register-based instructions, such as a VM instruction “VmI” 110 that includes an opcode for an operation to be performed (e.g., a Dalvik ADD operation), and one or more source and/or destination operands, such as SRC1, SRC2, and Dest, as shown in FIG. 1. Thus, when a VM instruction “VmI” 110 of the program 104 is loaded into the register Rm for processing, such register Rm contains the bitfields for the opcode and one or more virtual register-based source and/or destination operands.

As further shown, the memory 102 includes data 105 that may be accessed by the VM program 104. For instance, loads and stores may be performed for reading data from a referenced memory location (e.g., from SRC1 and SRC2) and/or for writing data to a referenced memory location (e.g., Dest). A register operand based interpreter of the VM may be employed, where such interpreter determines/computes the addresses of the referenced operands (e.g., SRC1, SRC2, Dest), which may be referred to as “address generation” or “address determination.” Generally, the address is determined through extracting the bit-fields for the operands in VmI 110 (now available in processor register Rm) and then applying an affine transformation. An affine function of the extracted bit-field (for the operand) provides the index where the actual data for the particular operand is stored in memory. Hence, an affine function of the operand field is generally the offset in the “base+offset” addressing mode of LOAD operations used to load the operand value from memory.

Conventionally, memory access operations (LOADS and STORES) for register operand based addressing on a VM are each two-pass operations. That is, to perform a LOAD of a value from a referenced memory location or to perform a STORE of a value to a referenced memory location by a register-based VM, two separate instructions are required to be executed.

For example, suppose that a program 104 executing on the VM 103 includes in its sequence of instructions, a Dalvik ADD operation, such as shown in the exemplary register Rm of FIG. 1. The Dalvik ADD operation would conventionally be performed as follows:
I. Load value SRC1 (** two-pass operation **)
   x=extract(Rm, width1, offset1)
   R2=LOAD[Rb+x]
II. Load value SRC2 (** two-pass operation **)
   y=extract(Rm, width2, offset2)
   R3=LOAD [Rb+y]
III. R1=R2 ADD R3
IV. Store value R1 to Dest (** two-pass operation **)
   z=extract(Rm, width3, offset3)
   STORE[Rb+z]=R1

As can be seen above, the memory access operations of loading the referenced value SRC1, loading the referenced value SRC2, and storing the computed result of the ADD operation (RD to the referenced Dest memory location each require two instructions, and thus two passes through the processor's pipeline.

FIG. 2 shows an example of hardware (HW) pipelined activity in a conventional pipeline for performing operand loads when both load/store and extract-bits use the same pipeline (assuming the pipeline supports forwarding). In this example, suppose that the following portion of the above-mentioned instruction listing is being executed:

Ins1→R1=extract(Rm, width1, offset1);

Ins2→Rx=load(Rbase+R1<<C);

Ins3→R2=extract (Rm, width2, offset2);

Ins4→Ry=load(Rbase+R2<<C);

The acronyms used for the pipeline stages in FIG. 2 are:

IF=Instruction fetch,

D & RR=Decode and Register read,

DC=Data computation,

RW=Register Write,

ADDRC=Address Computation, and

MA=Memory Access.

In this example, data computation and address computation are the same stage when it is the same pipeline. MA is an additional Stage for Load/Store instructions.

The illustrated instruction includes two LOAD operations, one to load operand

Rx and one to load operand Ry. As shown in FIG. 2, to execute the above instructions, a minimum of 8 clock cycles (assuming no cache misses) is required.

FIG. 3 shows an example of HW pipelined activity in a conventional pipeline for performing operand loads when load/store and extract-bits use different pipelines, which is possible in superscalar processors with dynamic pipeline scheduling using reservation stations. In this example, suppose that the following portion of the instruction listing is again being executed (as in the above example of FIG. 2):

Ins1→R1=extract(Rm, width1, offset1);

Ins2→Rx=load(Rbase+R1<<C);

Ins3→R2=extract (Rm, width2, offset2);

Ins4→Ry=load(Rbase+R2<<C);

As shown in FIG. 3, to execute the above instructions, a minimum of 7 clock cycles (assuming no cache misses) is required.

Various types of fused operations have been proposed in the past. For example, many fused operations have been proposed for performing computations, such as fusing operations together for performing addition, multiplication, or other computations in a single “fused” operation. However, while various types of fused operations have been proposed in the prior art, a proposal for fusing address extraction (for a register-based operand) and memory access (e.g., LOAD or STORE) into an operation that is performed in a single pass of a processor pipeline has gone unrecognized

### SUMMARY

The present disclosure generally relates to systems and methods for processing of memory access instructions, such as load and store instructions, in a processor-based system. Certain aspects of the present disclosure relate more specifically to processor hardware pipeline configurations for enabling efficient performance of memory access instructions, such as a pipeline configuration that enables, for a memory access operation request by a register-operand based virtual machine, extraction of a memory location to be accessed and performance of the requested memory access operation (e.g., load or store) on the extracted memory location. The instructions are performed in a single pass through the pipeline.

In one aspect of the present disclosure, a method to address and access an electronic memory includes receiving a microprocessor instruction in a processor having a hardware pipeline. The method also includes, responsive to the microprocessor instruction, computing a memory address to access, and executing a memory access operation on the computed address both in a single-pass through the hardware pipeline.

In yet another aspect, a method for accessing an electronic memory includes, responsive to a register-operand based virtual machine (VM) instruction for performing a memory access operation, performing derivation of a memory address with a bit-field value extracted from a processor register, combined with other registers or constants and a memory access operation at the derived memory address in a single pass through a processor's hardware pipeline.

In one aspect of the present disclosure, a method for performing a memory access operation by a register-operand based virtual machine is provided. The method includes receiving a single instruction to perform (i) an address extraction operation to extract an address and (ii) a memory access operation on the extracted address. The method also includes executing the single instruction to extract the memory address and to perform the memory access operation on the extracted memory address. In certain embodiments, the executing includes performing the address extraction operation and the memory access operation in a single pass through a processor's hardware pipeline.

In another aspect of the present disclosure, a system has an electronic memory; and a register-operand based virtual machine having an address mode enabling use of a single instruction to perform (i) an address extraction operation for extracting an address and (ii) a memory access operation on the extracted address. The system also has a processor having a defined instruction pipeline, configured to enable the address extraction operation and the memory access operation to be performed in a single pass through the instruction pipeline.

In yet another aspect, system has a processor having a hardware pipeline configured to perform, in a single pass through the hardware pipeline, both computation of a memory address of a virtual machine (VM) register that first involves extracting a bit-field value from a VM instruction already present in a processor register, and accessing the computed memory address.

### BRIEF DESCRIPTION OF THE DRAWINGS

For a more complete understanding of the present disclosure, reference is now made to the following description taken in conjunction with the accompanying drawings.

FIG. 1 is an illustration of an exemplary block diagram of a system implementing a register-based virtual machine (VM), which provides one exemplary system in which embodiments of the present disclosure may be employed.

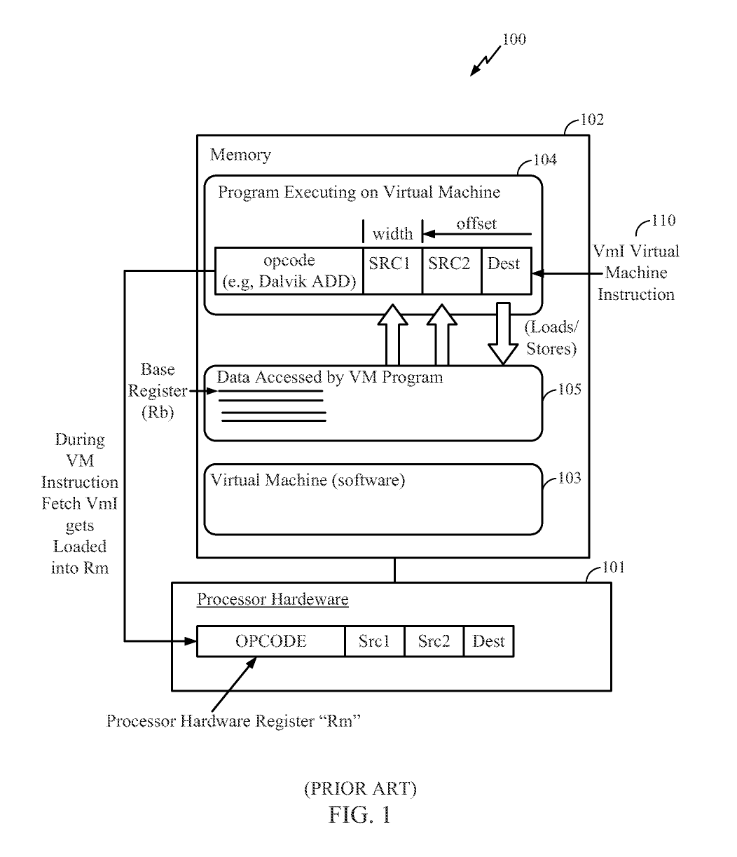

FIG. 2 is an illustration of an example of pipelined activity in a conventional pipeline for performing operand loads when both load/store and extract-bits use the same pipeline.

FIG. 3 is an illustration of an example of pipelined activity in a conventional pipeline for performing operand loads when load/store and extract-bits use different pipelines.

FIG. 4 is an illustration of an exemplary implementation of a pipeline configuration in accordance with an embodiment of the present disclosure, wherein extract bits operation may be implemented in various stages of the pipeline.

FIG. 5 is an illustration of a generic extract-bit hardware that uses two shifters in cascade according to one embodiment of the disclosure.

FIG. 6 is an illustration of a simplified hardware implementation for extract-bits on 16-bit words that uses multiplexers and supports 4-bit widths and offsets that are multiples of 4-bits according to one embodiment of the disclosure.

FIG. 7 is an illustration of another simplified hardware implementation for extract-bits on 16-bit words that uses multiplexers and supports two different categories of width-offset pairs according to one embodiment of the disclosure.

FIG. 8 is an illustration of the hardware pipelined activity in a pipeline configured in accordance with extract-bit operations performed in accordance with one embodiment of the disclosure.

### DETAILED DESCRIPTION

As described above, conventional memory access operations for register operand based addressing on a virtual machine (VM) are each two-pass operations. Using two instructions, however, degrades performance, wastes power, etc. Thus it is desirable to design a system where a load or store could be completed in a single instruction.

Certain embodiments of the present disclosure enable a single-pass instruction to be implemented for performing address extraction (for a register-based architecture) and a memory access operation. For instance, in certain embodiments, an instruction and a processor hardware pipeline configuration are provided that enable extraction of an address to be accessed and a memory access operation (LOAD or STORE) on the extracted address to be performed by a register-operand based VM in a single pass through the processor's pipeline. Various exemplary pipeline configurations that may be implemented for a processor to enable such single-pass address extraction and memory access operation for a register-based instruction are disclosed.

According to one embodiment, the following exemplary single-instruction address extraction and memory access operations for performing a load or a store may be employed:

Rx=LOAD(Rb+extract(Rm, width, offset));

STORE(Rb+extract(Rm, width, offset))=Rx.

Thus, the determination (or “extraction”) of the memory location to be accessed, and the performance of the memory access operation (e.g., load or store) may be combined into a single instruction, and those operations (address extraction and memory access of the extracted address) may be performed in a single pass through the processor's hardware pipeline. As described further, not only are the extract and memory access operations combined in certain embodiments, which, without the concepts present herein are conventionally done separately by two independent target processor instructions, but a processor hardware pipeline configuration may be implemented that enables the new instruction (i.e., the combined extraction and memory access operations) to be performed in a single pass through the pipeline.

Thus, in accordance with one embodiment, the above-mentioned Dalvik ADD operation, as one example, may be reduced to:

I. R2=LOAD(Rb+extract(Rm, width1, offset1)) ** single-pass LOAD **

II. R3=LOAD(Rb+extract(Rm, width2, offset2)) ** single-pass LOAD **

III. R1=R2 ADD R3

IV. STORE(Rb+extract(Rm, width3, offset3))=R1 ** single-pass STORE **

As can be seen above, the memory address extract operation may be embedded within the memory access operation, thereby enabling a single-instruction for performing an address extraction and a memory access of the extracted address for a register-operand based VM. Further, as discussed below, various different pipeline configurations may be employed for enabling the single VM instruction to be performed in a single pass through the pipeline.

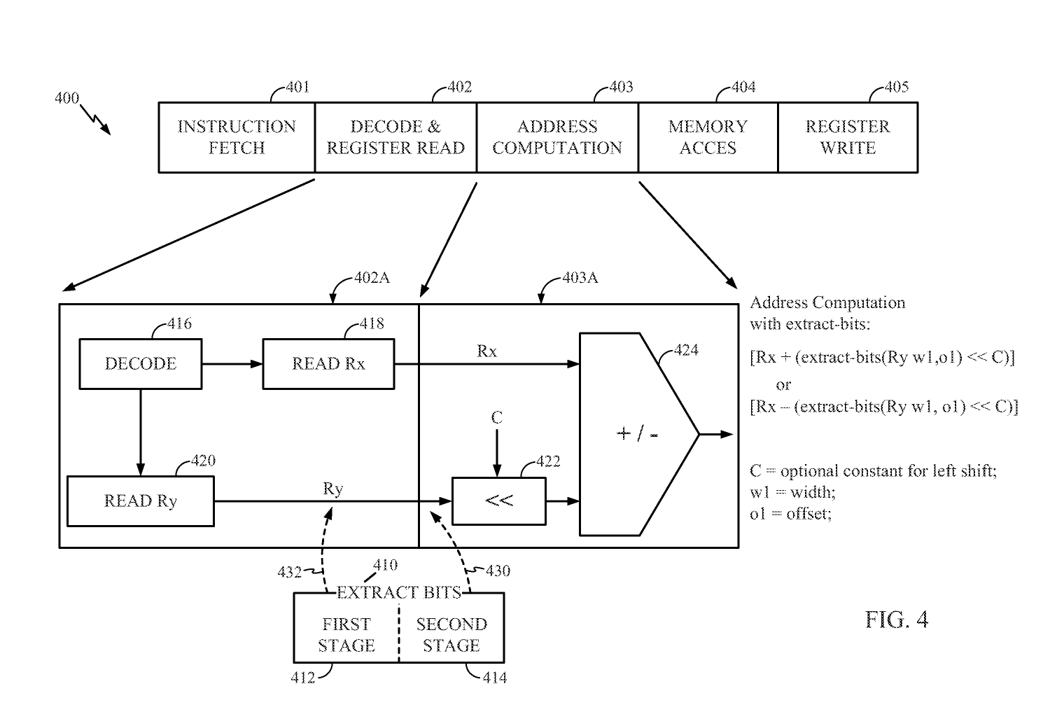

An exemplary implementation of a pipeline configuration is shown as a pipeline 400 in FIG. 4. As with the conventional pipeline, the exemplary pipeline 400 includes the following stages: instruction fetch 401, decode and register read 402, address computation 403, memory access 404, and register write 405. However, in this exemplary implementation, an extract bits operation, 410, may be implemented between the instruction fetch 401 and the memory access 404, as discussed further hereafter.

A logical representation of the operations performed in stage 402 is shown in block-diagram form as operational block 402A. That is, block 402A shows a block diagram illustrating the operations performed in stage 402 of the pipeline 400. That is, a decode 416 occurs, after which the register Rx is read 418 and the register Ry is read 420. Similarly, operational block 403A shows the logical operations performed in stage 403. Operational block 403A will be described in more detail below.

In this exemplary pipeline configuration 400, a generic “extract bits” operation 410 (for extracting a memory location for a referenced operand) may be fully implemented in various stages of the pipeline, either as a single stage operation 410 or split into a first stage of bit extraction 412 and a second stage of bit extraction 414. The integration of this new functionality into the pipeline provides a benefit to register-operand based virtual machines.

Choosing a location of the Extract Bits functionality in different decode/address computation stages is a matter of design choice offering different advantages. A number of embodiments for placement of the Extract Bits functionality are described below.

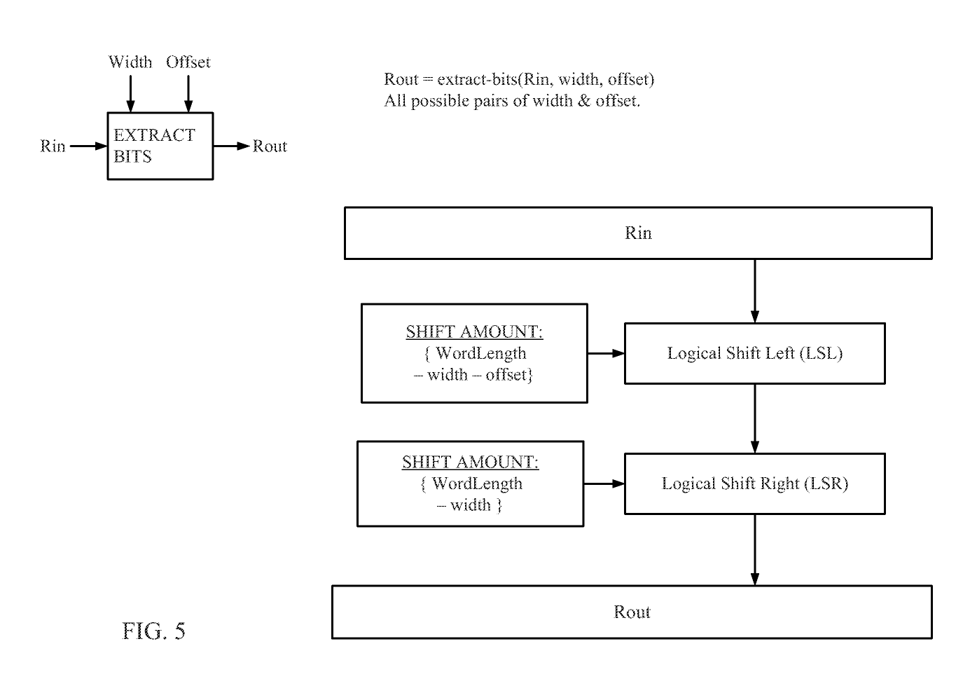

In one embodiment the Extract Bits functionality of operational block 410 is integrated as new functionality into the address-computation stage 403 of the processor pipeline 400. The Extract Bits operation may be inserted before the shifting block 422 in the address-computation stage 403 as shown by line 430. In this embodiment one of the fields of the VM instruction is extracted, shifted by a constant C (in block 422) and added to a hardware register Rx (in operational block 424). The result is the address of the virtual register in memory and will be accessed for loading/storing. The exemplary embodiment described above would support extraction of any bit field from the VM instruction, as shown in the exemplary implementation of FIG. 5.

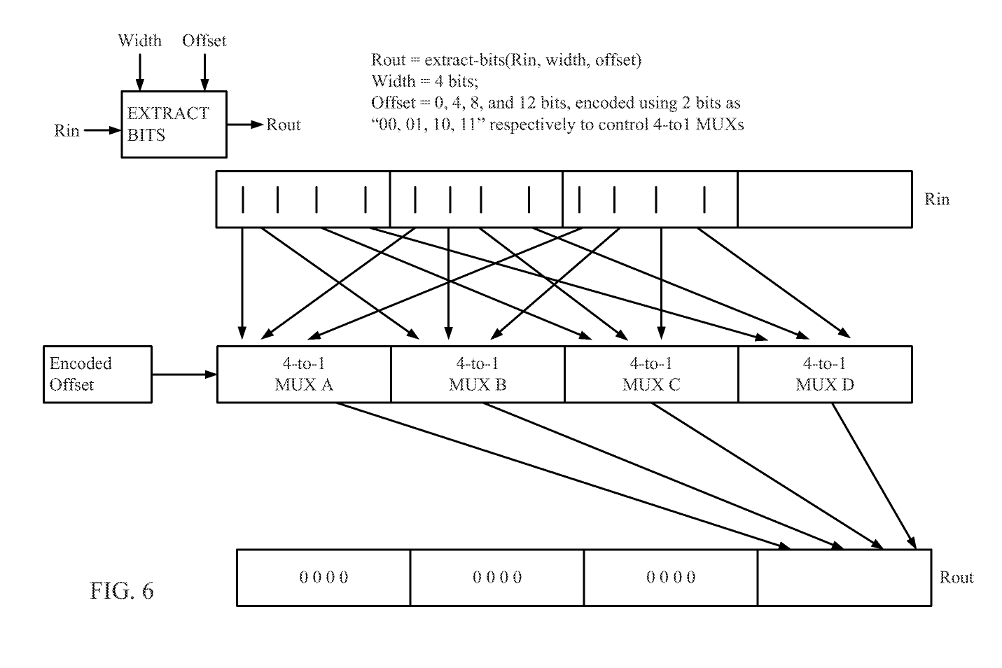

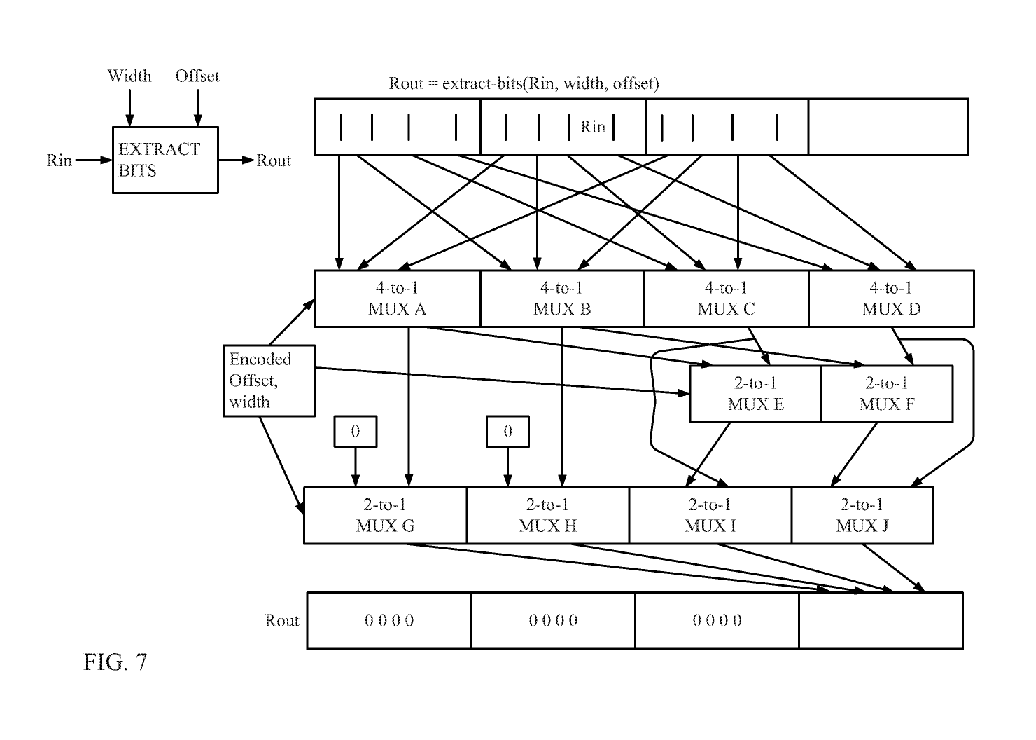

If the fields of the VM instruction are fixed-width and at fixed location, then the Extract Bits operation can be just a set of multiplexers, as shown in FIGS. 6 and 7. If the width and the offset are not fixed, then the hardware for implementing the Extract Bits operation may be more sophisticated, such as the exemplary implementation shown in FIG. 5.

FIG. 5 shows a generic extract-bit hardware that uses two shifters in cascade (logical left shift followed by logical right shift) and supports all valid pairs of widths and offsets. The left shift amount=(word-length-in-bits−width-in-bits−offset-in-bits). The right shift amount=(word-length-in-bits−width-in-bits).

FIG. 6 shows a simplified hardware implementation for extract-bits on 16-bit words that uses multiplexers and supports 4-bit widths and offsets that are multiples of 4-bits. Such an embodiment could be extended to 32-bit words.

FIG. 7 shows another simplified hardware implementation for extract-bits on 16-bit words that uses multiplexers and supports two different categories of width-offset pairs: (i) 2-bit width with offsets that are multiples of 2-bits, and (ii) 4-bit widths and offsets that are multiples of 4-bits. Such an embodiment could also be extended to 32-bit words.

In one embodiment a modified Extract Bits functionality of operational block 410 is integrated into the existing logical shift left operation 422. Incorporating Extract Bits functionality with the logical shift left allows for an implementation with fewer gates and faster cycle time. In this embodiment the modified Extract Bits functionality may only support a limited set of widths and offsets, examples of which are shown in FIGS. 6 and 7.

In another embodiment the Extract Bits functionality of operational block 410 is integrated as new functionality into the decode & register read stage 402 of the processor pipeline 400. The Extract Bits operation may be inserted after the Read Ry block 420 in the decode & register read stage 402 as shown by line 432. This implementation may be used if one determined that there is slack in the decode stage 402 of a given system such that it can still meet cycle timing with this extract operation in the path.

In another embodiment the Extract Bits functionality of operational block 410 is split into two pipeline stages, a first stage 412 and a second stage 414. For example, if two levels of multiplexing are needed to extract bits in a given system implementation, the first level might happen in the decode stage 402 and the second in the address-compute stage 403. Similarly, when the extract-bits operation is implemented by a cascade of two shifters (LSL, followed by LSR), as in the example shown in FIG. 5, the LSL could be implemented in the decode stage 402, while the LSR is implemented in the address computation stage 403. In such an embodiment the Extract Bits first stage 412 may be located after the Read Ry block 420 in the decode & register read stage 402 (as shown by line 432) and the Extract Bits second stage 414 may be located before the shifting block 422 in the address-computation stage 403 as shown by line 430. In this manner the full hardware logic for performing Extract Bits is partitioned across the two consecutive pipeline stages, showing an alternative that enables timing to be achieved by partitioning the work across stages.

In another embodiment the address computation stage 403 may be split into two stages where the first address computation stage contains the Extract Bits functionality 410 and the second address computation stage contains the logical functionality shown in block 403A. This alternative may be desirable for a highest-speed implementation. In this configuration, the first address computation stage may include the shift operation block 422. This configuration may be useful to balance the two stages of address computation.

The above implementations configure the processor's hardware pipeline to support both extracting a memory location for a referenced operand and accessing (performing a load or store) the extracted memory location in a single pass through the pipeline.

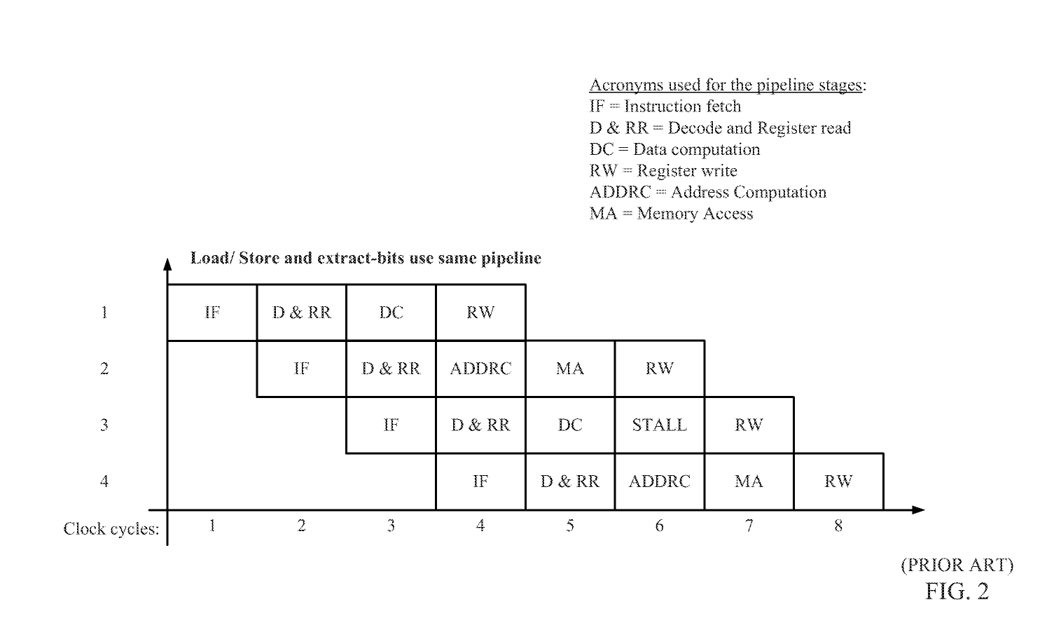

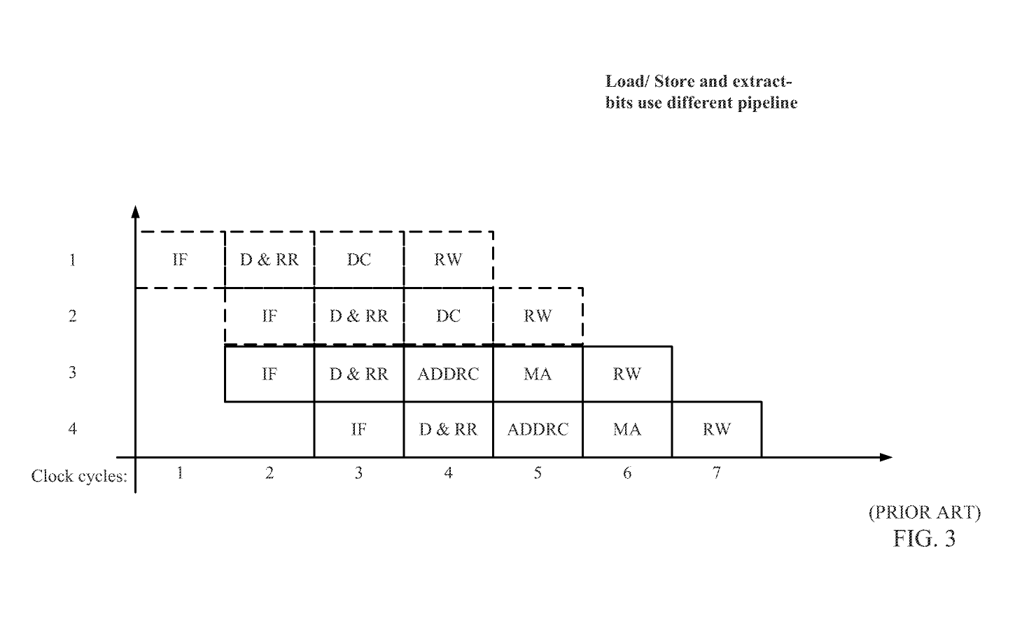

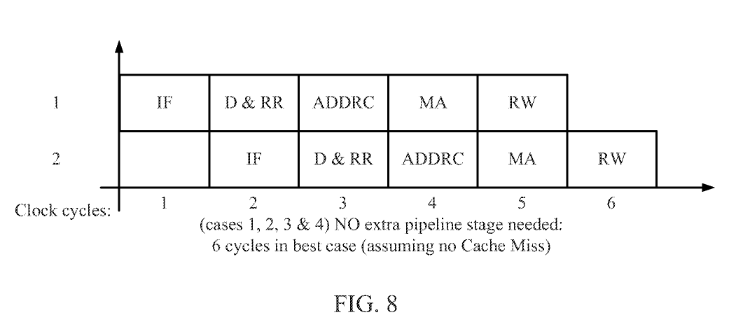

FIG. 8 shows an example of the hardware pipelined activity in a pipeline configured in accordance with one embodiment disclosed for performing operand loads. In this example, the instructions for address extraction and memory access are integrated into a single instruction. Thus, the portion of the instruction listing considered in the above examples of FIGS. 2 and 3 may be reduced to the following instructions:

Ins5→Rx=load(Rbase+extract(Rm, width1, offset1)<<C);

Ins6→Ry=load(Rbase+extract(Rm, width2, offset2)<<C).

The acronyms used for the pipeline stages in FIG. 8 are:

IF=Instruction fetch,

D & RR=Decode and Register read,

RW=Register Write,

ADDRC=Address Computation, and

MA=Memory Access.

FIG. 8 shows the pipeline activity for executing the above instructions for a pipeline configured in accordance with the embodiments discussed above. As shown, a minimum of 6 clock cycles (assuming no cache misses) is required for completing the instructions.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the technology of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method to address and access an electronic memory comprising:
receiving a microprocessor instruction in a processor having a hardware pipeline; and
responsive to the microprocessor instruction, computing a memory address to access, and executing a memory access operation on the computed address both in a single-pass through the hardware pipeline.

2. The method of claim 1 wherein the microprocessor instruction, comprises a memory access operation request by a register-operand based virtual machine (VM).

3. The method of claim 2 wherein the memory address is computed by extracting a bit-field value that represents a VM register from a processor register that contains bits of a Virtual Machine instruction (VMI), and then combining the extracted bit-field value with at least a second value to compute the address of the VM register in memory.

4. The method of claim 3, further comprising combining a second value with the extracted bit field value.

5. The method of claim 1, in which the memory access operation comprises one of a load operation and a store operation.

6. The method of claim 1 wherein the processor hardware pipeline comprises an instruction fetch stage, a decode and register read stage, an address computation stage, a memory access stage, and a register write stage, and in which:
the computing the memory address is performed before or within the address computation stage.

7. The method of claim 1 wherein the hardware pipeline comprises an instruction fetch stage, a decode and register read stage, an address computation stage, a memory access stage, and a register write stage, and in which:
the computing the memory address is performed in the decode and register read stage.

8. The method of claim 1 wherein the hardware pipeline comprises an instruction fetch stage, a decode and register read stage, an address computation stage, a memory access stage, and a register write stage, and in which:
the computing the memory address comprises:
performing a first part of the computing in the decode and register read stage; and
performing a second part of the computing in the address computation stage.

9. The method of claim 1 wherein the hardware pipeline comprises an instruction fetch stage, a decode and register read stage, a first address computation stage, a second address computation stage, a memory access stage, and a register write stage, and in which:
the computing the memory address is performed in the first address computation stage.

10. A method for accessing an electronic memory comprising:
responsive to a register-operand based virtual machine (VM) instruction for performing a memory access operation, performing in a single-pass through a processor's hardware pipeline:
derivation of a memory address with a bit-field value extracted from a processor register, combined with other registers or constants, and
the memory access operation at the derived memory address.

11. A method for performing a memory access operation by a register-operand based virtual machine, the method comprising:
receiving a single instruction to perform:
an address extraction operation for extracting a memory address, and
a memory access operation on the extracted address; and
executing the single instruction to extract the memory address and to perform the memory access operation on the extracted memory address.

12. The method of claim 11 wherein the executing comprises:
performing the address extraction operation and the memory access operation in a single pass through a processor's hardware pipeline.

13. A system comprising:
an electronic memory;
a register-operand based virtual machine having an address mode enabling use of a single instruction to perform:
an address extraction operation that extracts an address, and
a memory access operation on the extracted address; and
a processor having a defined instruction pipeline configured to enable the address extraction operation and the memory access operation to be performed in a single pass through the instruction pipeline.

14. A system comprising:
a processor having a hardware pipeline configured to perform, in a single pass through the hardware pipeline, both
computation of a memory address of a virtual machine (VM) register that first involves extracting a bit-field value from a VM instruction already present in a processor register, and
accessing the computed memory address.

15. The system of claim 14 wherein the pipeline comprises an instruction fetch stage, a decode and register read stage, an address computation stage, a memory access stage, and a register write stage, and in which:
the extracting the bit-field value occurs before or within the address computation stage.

16. The system of claim 14 wherein the pipeline comprises an instruction fetch stage, a decode and register read stage, an address computation stage, a memory access stage, and a register write stage, and in which:
the extracting the bit-field value occurs in the decode and register read stage.

17. The system of claim 14 wherein the pipeline comprises an instruction fetch stage, a decode and register read stage, an address computation stage, a memory access stage, and a register write stage, and in which:
a first part of the extracting the bit-field value occurs in the decode and register read stage; and
a second part of the extracting the bit-field value occurs in the address computation stage.

18. The system of claim 14 wherein the pipeline comprises an instruction fetch stage, a decode and register read stage, a first address computation stage, a second address computation stage, a memory access stage, and a register write stage, and in which:
the extracting the bit-field value occurs in the first address computation stage.

19. The system of claim 14 wherein the extracting the bit-field value is implemented by a cascade of two shifters, and wherein a first of the two shifters is performed in a decode and register read stage and a second of the two shifters is performed in an address computation stage.
